(19) United States
(12) Patent Application Publication
(10) Pub. No.: US 2008/0017310 A1
(43) Pub. Date: Jan. 24, 2008

(54) Use of Partially Saponified Vinly Ester Polymers in Hot-Melt Adhesive Compositions

(75) Inventors: Rene Grawe, Burghausen (DE); Peter Ball, Emmerting (DE); Werner Bauer, Burgkirchen (DE); Robert Tangelder, Laren (NL)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMER SYSTEMS GMBH & CO. KG, Burghausen (DE)

(21) Appl. No.: 10/597,798

(22) PCT Filed: Feb. 10, 2005
(86) PCT No.: PCT/EP05/01361

§ 371 Date: May 10, 2007

(30) Foreign Application Priority Data
Feb. 12, 2004 (DE) 10 2004 007 028.8

(51) Int. Cl. C08L 29/00; B32B 7/12; C09J 129/04

(52) U.S. Cl. 156/327; 524/315; 524/383; 524/563; 526/319

(57) ABSTRACT

Hot melt adhesives with good flow characteristics, resistance to gelling at elevated temperature, strong adhesion, and yet which can be easily removed from substrates with water, are formulated with one or more partially saponified vinyl ester homo- or copolymers having a molecular weight below 70,000 Da, a degree of hydrolysis of from 62 to 86 mol %, the adhesives being free of mannitol and anionic surfactants.

Use of partially saponified vinyl ester polymers in hot-melt adhesive compositions

The invention relates to the use of partially saponified vinyl ester homopolymers and copolymers in hot-melt adhesive compositions. Hot-melt adhesives (hotmelts) are used in the packaging sector, among others, as adhesives: for example, as adhesives for paper, paperboard, cardboard, and wood. Common hot-melt adhesives are based on ethylene-ethyl acrylate copolymers, polyamides, and ethylene-vinyl acetate copolymers. In train with the increasing recycling of packaging materials there is a need for the adhesives to be readily detachable from the packaging materials. Ideally they ought to be amenable to removal by washing with water. The abovementioned standard hotmelts do not meet this condition.

JP-A 2001-220563 discloses a water-soluble or water-dispersible hot-melt adhesive composition which comprises polyvinyl alcohol having a degree of polymerization of ≦350 and a degree of hydrolysis of ≦80 mol %, mannitol, and polypropylene glycol. A disadvantage there is the tendency to gel under long-term temperature exposure, owing to the high viscosity. JP-A 62-043477 describes a hot-melt adhesive based on a polyvinyl alcohol having a degree of polymerization of preferably 100 to 1500 and a degree of hydrolysis of 20 to 95 mol %, the vinyl alcohol units being arranged in blocks. JP-A 2003-003140 describes hot-melt adhesives comprising a polyvinyl alcohol (degree of hydrolysis <60 mol %), an anionic emulsifier, and plasticizer. Owing to the anionic emulsifier the water resistance of the bond is unsatisfactory. A disadvantage of these hot-melt adhesives is their low bond strength, excessively high price, excessively high melt viscosity, and the associated tendency to gel.

It was an object of the invention to develop a hot-melt adhesive composition which exhibits good fluidity, leads to stable bonds, but is readily removable with water from the material to which sticking was intended.

The invention provides for the use of partially saponified vinyl ester homopolymers and copolymers in hot-melt adhesive compositions, characterized in that the vinyl ester homopolymers and copolymers have a molecular weight Mw<70000 and the partially saponified vinyl ester homopolymers and copolymers have a degree of hydrolysis of 62 to 86 mol %, and the hot-melt adhesive composition contains no mannitol.

Suitable partially saponified vinyl ester homopolymers and copolymers are partially saponified vinyl ester polymers having a degree of hydrolysis of 62 to 86 mol %, preferably 65 to 75 mol %, most preferably 70 mol %. The weight-average molecular weight Mw is <70000, preferably 5000 to 30000 (determined by means of gel permeation chromatography), the molecular weight being determined prior to the saponification and the molecular weight Mw therefore referring to the as yet unsaponified vinyl ester homopolymer or copolymer. The hot-melt adhesive composition contains no anionic emulsifiers. In the partially saponified vinyl ester homopolymers and copolymers the vinyl alcohol units are randomly distributed.

Suitable vinyl esters are vinyl esters of unbranched or branched carboxylic acids having 1 to 18 carbon atoms. Preferred vinyl esters are vinyl acetate, 1-methylvinyl acetate, vinyl propionate, vinyl butyrate, vinyl 2-ethylhexanoate, vinyl laurate, vinyl pivalate, and vinyl esters of a-branched monocarboxylic acids having 5 to 13 carbon atoms, examples being VeoVa9^{R} or VeoVa10^{R} (tradenames of Resolution Performance Products), and also mixtures thereof. Vinyl acetate is particularly preferred.

Besides the vinyl ester units it is also possible where appropriate for one or more monomers to be copolymerized from the group encompassing methacrylic esters and acrylic esters of alcohols having 1 to 15 carbon atoms, olefins, dienes, vinylaromatics, ethylenically unsaturated monocarboxylic and dicarboxylic acids, and vinyl halides. Suitable monomers from the group of the esters of acrylic acid or methacrylic acid are methyl acrylate, methyl methacrylate, n-, iso-, and tert-butyl acrylate, 2-ethylhexyl acrylate, and norbornyl acrylate. Suitable dienes are 1,3-butadiene and isoprene. Examples of polymerizable olefins are ethene and propene. Vinyl-aromatics which can be copolymerized are styrene and vinyltoluene. Examples of suitable monocarboxylic and dicarboxylic acids are acrylic acid, methacrylic acid, crotonic acid, and fumaric acid. From the group of the vinyl halides it is common to use vinyl chloride. Most preference is given to ethylene, crotonic acid, and vinyl chloride. The fraction of these comonomers is calculated such that the fraction of vinyl ester monomer is >50 mol % in the vinyl ester polymer.

Maximum preference is given to partially saponified vinyl acetate homopolymers, partially saponified vinyl acetate-vinyl laurate copolymers, vinyl acetate-crotonic acid copolymers, and mixtures thereof.

The partially saponified vinyl ester homopolymers and copolymers can be prepared in a known way from the corresponding vinyl ester polymers by means of saponification (hydrolysis). The vinyl ester polymers are prepared in a known way preferably by bulk polymerization, suspension polymerization or by polymerization in organic solvents, with particular preference in alcoholic solution. The polymerization is carried out under reflux at a temperature of 55° C. to 100° C. and initiated free-radically by addition of commonplace initiators.

The saponification of the vinyl ester polymers takes place in a manner known per se by for example the belt or extruder method or in a stirred tank, in the alkaline or acidic range with addition of acid or base. Preferably the solid vinyl ester resin is taken up in alcohol, methanol for example, to set a solids content of 15% to 70% by weight. The hydrolysis is preferably carried out in the basic range, by addition of NaOH, KOH or NaOCH₃, for example. The base is used generally in an amount of 1 to 5 mol % per mole of ester units. The hydrolysis is carried out at temperatures from 30° C. to 70° C. After the end of the hydrolysis the solvent is removed by distillation. Alternatively the polyvinyl alcohol can be obtained as an aqueous solution by successive addition of water while the solvent is distilled off.

The hot-melt adhesive composition may further comprise 0 to 50% by weight, preferably 15% to 50% by weight, of sorbitol, based in each case on the total weight of the hot-melt adhesive composition. This addition reduces the melt viscosity and enhances the flexibility of the adhesive bond and the adhesion to different substrates.

To reduce the surface tension and the viscosity of the melt it is possible further to admix the hot-melt adhesive composition with waxes, such as hydrocarbon waxes, polyethylene waxes, and polyamide waxes, for example. Preference is given to polyamide waxes such as ethylenebisstearamide wax. The amount used is preferably 0.1% to 15% by weight, based on the total weight of the hot-melt adhesive composition.

Suitable additives for improving the compatibility of the individual components of the hot-melt adhesive composition are fatty acid esters such as glycerol monostearate and glycerol distearate, which where appropriate are used in a weight ratio of 0.1:1 to 1:1 with respect to the wax fraction of the hot-melt adhesive composition.

Where appropriate it is also possible for water-soluble plasticizers to be included, such as glycerol esters of rosin, methyl esters of rosin, pentaerythritol esters of rosin, and polyalkylene glycols, preferably polypropylene glycol. The amounts in the hot-melt adhesive composition are 0 to 10% by weight, preferably 1% to 5% by weight, based on the overall weight of the hot-melt adhesive composition.

Examples of further additives include antioxidants for increasing the gelling stability, based on corresponding phosphites, sterically hindered phenols, lactones or mixtures thereof. Antioxidants of this kind are available commercially and are employed where appropriate in an amount of up to 2% by weight, based on the overall weight of the hot-melt adhesive composition.

The hot-melt adhesive composition is suitable for use as adhesive for paper, paperboard, cardboard, wood, and plastic, especially as a label adhesive for PET containers. The hot-melt adhesive composition is distinguished over the prior art by virtue of the fact that the adhesive is water-soluble and yet remains thermoplastically processible, and the adhesive is readily amenable to removal by washing when substrates bonded using it are recycled.

The examples which follow serve for further illustration of the invention:

The formulas specified in Table 1 were tested:

Solid resin: partially saponified polyvinyl acetate with degree of hydrolysis =70 mol % and molecular weight Mw (PVAC)=10000

PPG 400: polypropylene glycol with OH number of 400

Licolub: ethylenebisstearamide wax

Tegomuls: glycerol monostearate

TABLE 1

| | Example | | | | | | |
|---|---|---|---|---|---|---|---|
| | C1 | 2 | 3 | 4 | 5 | 6 | 7 |
| Solid resin [g] | 60 | 96 | 75 | 70.3 | 66.0 | 87.5 | 81.0 |
| Sorbitol [g] | | | 21 | 19.7 | 18.5 | | |
| Mannitol [g] | 36 | | | | | | |
| PPG 400 [g] | 4.0 | 4.0 | 4.0 | 3.8 | 3.5 | 4.7 | 4.3 |
| Licolub [g] | | | | 5.0 | 8.0 | 6.2 | 9.8 |
| Tegomuls [g] | | | | 1.3 | 4.0 | 1.6 | 4.9 |

The specified formulas were used to conduct the following test, whose results are summarized in Table 2:

Determination of Melt Viscosity [Pas]:

The melt viscosity was determined by measuring the hot-melt adhesives using a high-temperature rheometer from Bohlin and plotting the rheology curves in the temperature range 100° C. to 180° C. (gap distance 500 μm, frequency 1 Hz, Def 0.05, temperature ramp 5° C./min, oscillating measurement).

Determination of Water Solubility [s]:

The water-solubility was determined by sealing 2 cotton strips (1 cm×4 cm) with the corresponding formulation at 180° C. The sealed bond was immersed in a waterbath at room temperature and loaded with a weight of 10 g. A measurement was made of the time until the bond had undergone complete parting.

TABLE 2

| | Example | | | | | | |
|---|---|---|---|---|---|---|---|
| | C1 | 2 | 3 | 4 | 5 | 6 | 7 |
| Viscosity at | 1410 | 2610 | 612 | 1000 | 942 | 333 | 622 |
| 120° C. [Pas] | | | | | | | |
| H₂O solubility [s] | 245 | 107 | 366 | 170 | 214 | 250 | 280 |

Discussion of Results:

In comparison to the prior art formulation the inventive formulations combine generally much-improved flow behavior with adhesive films that exhibit comparable water-solubility.

1-10. (canceled)

11. A process for adhesively bonding surfaces, comprising applying to at least one surface a molten hot melt adhesive, comprising:
at least one partially saponified vinyl ester homopolymer or copolymer having a molecular weight Mw<70,000; a degree of hydrolysis of 62 to 86 mol %; and a random distribution of vinyl alcohol moieties, wherein the hot-melt adhesive composition is free of mannitol and anionic surfactants; and
contacting said surfaces to be bonded with said molten adhesive therebetween, and allowing said molten adhesive to solidify.

12. The process of claim 11, wherein the degree of hydrolysis is 65 to 75 mol %.

13. The process of claim 11, wherein the molecular weight Mw is 5000 to 30,000.

14. The process of claim 11, wherein at least one partially saponified vinyl ester homopolymer or copolymer is selected from the group consisting of partially saponified vinyl acetate homopolymers, partially saponified vinyl acetate-vinyl laurate copolymers, and partially saponified vinyl acetate-crotonic acid copolymers.

15. The process of claim 11, wherein the hot-melt adhesive composition further comprises sorbitol.

16. The process of claim 11, wherein the hot-melt adhesive composition further comprises at least one wax.

17. The process of claim 11, wherein the hot-melt adhesive composition further comprises at least one fatty acid ester.

18. The process of claim 11, wherein the hot-melt adhesive composition further comprises at least one water-soluble plasticizer.

19. The process of claim 11, wherein the hot-melt adhesive composition further comprises at least one antioxidant.

20. The process of claim 11, wherein at least one surface is a surface of paper, paperboard, cardboard, wood, or plastic.

21. A hot melt adhesive composition suitable for use in the process of claim 11, comprising:
at least one partially saponified vinyl ester homopolymer or copolymer having a molecular weight Mw<70,000; a degree of hydrolysis of 62 to 86 mol %; and a random distribution of vinyl alcohol moieties, wherein the hot-melt adhesive composition is free of mannitol and anionic surfactants.

22. The composition of claim 21, wherein the degree of hydrolysis is 65 to 75 mol %.

23. The composition of claim 21, wherein the molecular weight Mw is 5000 to 30,000.

24. The composition of claim 21, wherein at least one partially saponified vinyl ester homopolymer or copolymer is selected from the group consisting of partially saponified vinyl acetate homopolymers, partially saponified vinyl acetate-vinyl laurate copolymers, and partially saponified vinyl acetate-crotonic acid copolymers.

25. The composition of claim 21, further comprising sorbitol.

26. The composition of claim 21, further comprising at least one wax.

27. The composition of claim 21, further comprising at least one fatty acid ester.

28. The composition of claim 21, further comprising at least one water-soluble plasticizer.

29. The composition of claim 21, further comprising at least one antioxidant.

30. The composition of claim 21, wherein the degree of hydrolysis is 65 to 75 mol %; the molecular weight is from 5000 to 30,000; the partially saponified vinyl ester polymer is a vinyl acetate polymer; and further comprising at least two further ingredients selected from the group consisting of sorbitol, wax, fatty acid ester, water soluble plasticizer, and antioxidant.
